(19) United States
(12) Patent Application Publication
(10) Pub. No.: US 2003/0229861 A1
(43) Pub. Date: Dec. 11, 2003

(54) Semi-automatic antenna design via random sampling and visualization

(76) Inventors: Aaron J. Quigley, Aberglasslyn (AU); Darren L. Leigh, Belmont, MA (US); Neal B. Lesh, Cambridge, MA (US); Joseph W. Marks, Belmont, MA (US); Kathleen Ryall, Cambridge, MA (US); Kent B. Wittenburg, Lynnfield, MA (US)

Correspondence Address: Patent Department, Mitsubishi Electric Research Laboratories, Inc., 201 Broadway, Cambridge, MA, 02139, US

(21) Appl. No.: 10/166,414

(22) Filed: Jun. 10, 2002

(51) Int. Cl. G06F 17/50

(52) U.S. Cl. 716/1

(57) ABSTRACT

An antenna design method is supplied with antenna design parameters in an antenna specification. The design specification is parsed to produce free variables and constraints. A random sampling of a set of antenna designs is generated from the free variables and constraints in the form of performance vectors. The performance vectors are then dispersed in a design space which is visualized vectors as antenna designs, and a particular antenna design is selected as a useful antenna design.

### FIELD OF THE INVENTION

The present invention relates generally to designing antennas, and more particularly to designing antennas via sampling and visualization of computer generated designs.

### BACKGROUND OF THE INVENTION

Computer-based optimization for design tasks has been applied to many problems, including antenna design. However, computerized design does not always work well. The optimization problems are often intractable; and it is often impossible to consider all relevant design criteria in the optimization process. Moreover, it is also often difficult to capture all relevant design issues and tradeoffs in a single mathematical objective function. Therefore, antenna designers typically specify and refine antenna designs manually and use computers only to evaluate candidate designs by computer simulation. The designers can then apply experience and judgment to recognize and refine the most useful antenna designs.

### SUMMARY OF THE INVENTION

The invention provides a method and system for designing antennas that is a middle ground between a traditional manual approach and a fully automatic computer design process. The method according to the invention generates a set of samples of possible antenna designs, and then relies on human judgment to select useful designs using a visualization of the design space generated by the computerized design process.

Key elements of the system are a parallel method for intelligently sampling a space of possible antenna designs, and a graphical user interface for visualizing and exploring candidate designs and managing the sampling process.

More particularly, the invention provides a method for designing antennas. The method is first supplied with antenna design parameters in an antenna specification. The design specification is parsed to produce free variables and constraints.

A random sampling of a set of antenna designs is generated from the free variables and constraints in the form of performance vectors. The performance vectors are then dispersed in a design space which is visualized vectors as antenna designs, and a particular antenna design is selected as a useful antenna design.

### BRIEF DESCRIPTION OF THE DRAWINGS

FIG. 1 is a flow diagram of the antenna design system and method according to the invention;

FIG. 2 is a block diagram of pseudo-code for dispersing antenna designs in a design space according to the invention;

FIG. 3 is an interactive visualization of the antenna design space used by the invention; and

FIG. 4 is an interactive visualization of performance metrics of a collection of antenna designs.

### DETAILED DESCRIPTION OF THE PREFERRED EMBODIMENT

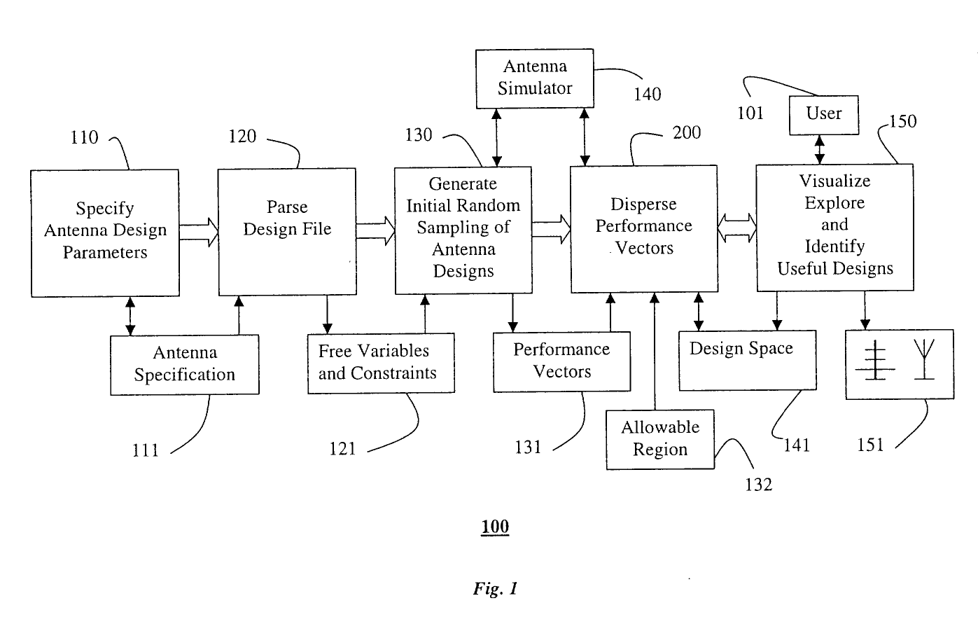

FIG. 1 shows a system and method 100 for designing antennas semi-automatically according to our invention. A user of the system 100 supplies 110 an initial set of antenna specification (S) 111. The antenna specification 111 describes the antenna geometry, and other physical-parameter inputs. In addition, the user also indicates which variables of the antenna specification 111 are free to be varied during the design process, and minimum and maximum values for these variables. This information can be specified in an XML file that can be edited manually, although other editable file formats can also be used.

The XML antenna specification 111 is parsed 120 into free variables and constraints 121. The free variables and constraints are then used to generate 130 an initial random set of antenna designs by sampling the free variables uniformly over their valid ranges. The designs are expressed in the form of performance vectors 131. However, a uniform sampling of the free variables rarely produces a representative sampling of antenna designs.

To generate a representative sample of antenna designs requires an intelligent sampling process that we call dispersion 200, described in greater detail below. A key requirement for dispersion process 200 is a function that quantifies a difference between antenna designs. This difference metric is based on the performance characteristics of an antenna. Therefore, we encode the performance characteristics of the generated antenna designs as the performance vector 131.

Each performance vector contains m real numbers that represent design factors, for example, the antenna's gain, front-to-back ratio, front-to-side lobe ratio, cost (total wire length), half-power beam width, and voltage standing-wave ratio (VSWR) for a given input impedance. In our system, we determine the performance vectors 131 from an antenna specification with an antenna simulator 140, e.g., the well known NEC-2 simulator, though in principle any simulator could be used. We define a difference between two antennas to be the Euclidean distance between their two normalized m-dimensional performance vectors 131. It should be understood that other difference metrics can also be used.

Weight and Warping

Weights can be assigned to selected performance vectors prior to computing the Euclidean distances. The weights are used to increase the distance between two antenna designs for selected design factors. For example, increasing the weight of the “cost” vectors increases the effect of the difference in costs between two antenna designs when determining their pair-wise Euclidean distance. This allows the user to obtain a greater diversity for performance vectors that are considered more important.

In addition, the performance vectors can be “warped.” By applying a non-linear function to the performance vectors, prior to determining the Euclidean distances, distances in certain ranges of values are amplified. For example, an exponential function, e.g., f(x)=2^{x} for the cost performance vector. Then, a difference in cost from 6 to 7 is much larger than a cost from 2 to 3.

Dispersion

The goal of the dispersion process 200 is to produce a set of sample of antenna designs for which the associated performance vectors are as broadly distributed as possible in an m-dimensional design space 141. It should be noted that dispersion process 200 can be invoked multiple times until a useful antenna design is found.

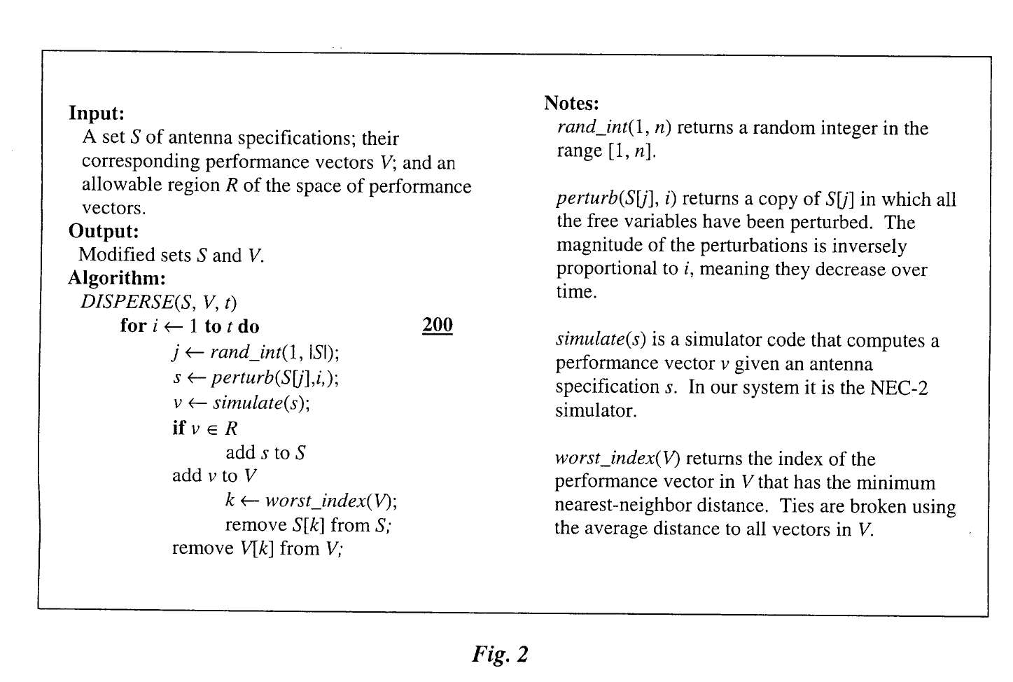

FIG. 2 shows the process 200 for accomplishing this. Input to the dispersion process the set S of antenna specifications 111, their corresponding performance vectors V 131, and an allowable region R 132 of the space of performance vectors. The output of the process includes modified sets S and V.

In each iteration, a new antenna design is generated by perturbing the free variables of a previously generated sample. The performance vector (V) 131 for this new candidate design is determined by the antenna simulator 140. If the new performance vector contributes more to the diversity than any other sample in the design space 141, then the new performance vector replaces the latter in the design space. In other words, the diversity is increased if the difference metric between the performance vectors is maximized.

The dispersion process 200 may require many calls to the antenna simulator 140 and is embedded in an interactive system, which mandates some degree of system responsiveness. We therefore parallelize the dispersion process 200 by distributing simulator calls to a cluster of over a hundred computers. The resulting parallel process is a minor variation of the serial version described in FIG. 2.

The first invocation of the dispersion process 200 typically produces a wide variety of designs. Step 150 enables the user 101 to explore the samples in the design space to locate and identify the most useful designs 151.

Visualized Design Space

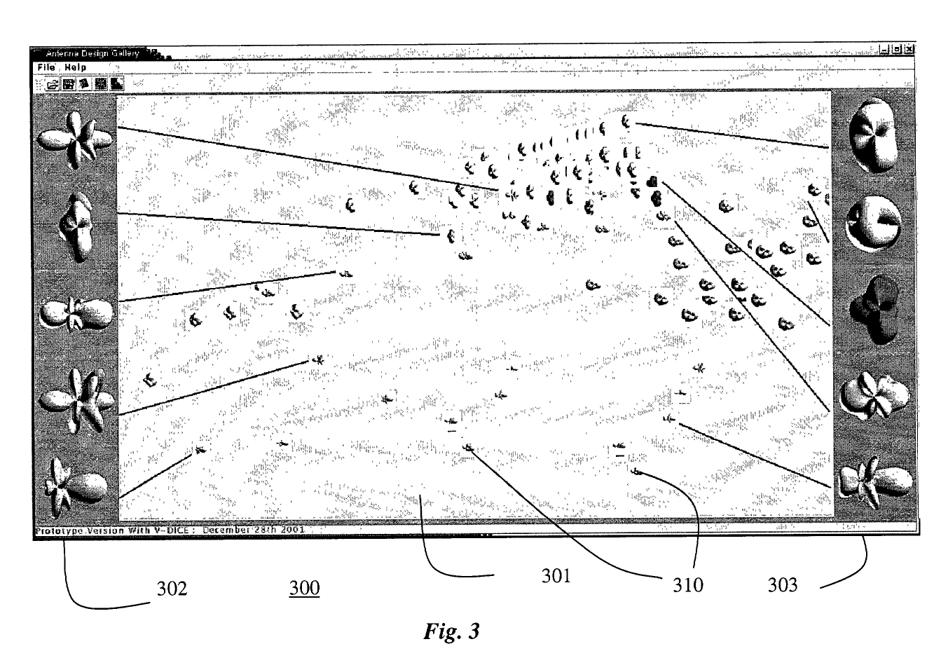

This exploration process is facilitated by a graphical user interface 300, shown in FIG. 3. A central panel 301 contains thumbnail images 310 of gain plots for each antenna in the design space. The color of the plot indicates the value, e.g., low, medium, or high, of some significant scalar value, in this case the VSWR performance measure. The thumbnails are positioned so that antennas with similar performance vectors are clustered close to each other.

In other words, distance in the display correlates with distance in the m-dimensional design space 141 implied by the difference metric. This visualization, which is determined using a technique called multi-dimensional scaling enables the user visualize a dispersion in the design space, see Marks et al., “Design Galleries: A General Approach to Setting Parameters for Computer Graphics and Animation,” in Proceedings of ACM SIGGRAPH 97, pp. 389-400, Los Angeles, Calif., August, 1997, and U.S. Pat. No. 5,894,309, “System for modifying lighting in photographs,” issued on Apr. 13, 1999 to Freeman et al., incorporated herein by reference.

The thumbnail images can be browsed by panning and zooming. The user can “bookmark” or save “interesting” antennas by moving them to the surrounding “gallery” 302-303. Selecting a saved antenna causes its corresponding thumbnail to be highlighted, and vice versa. The lines connecting saved antennas to their thumbnails in FIG. 3 do not appear in the actual interface, but are shown here for exposition.

Visualized Performance Metrics

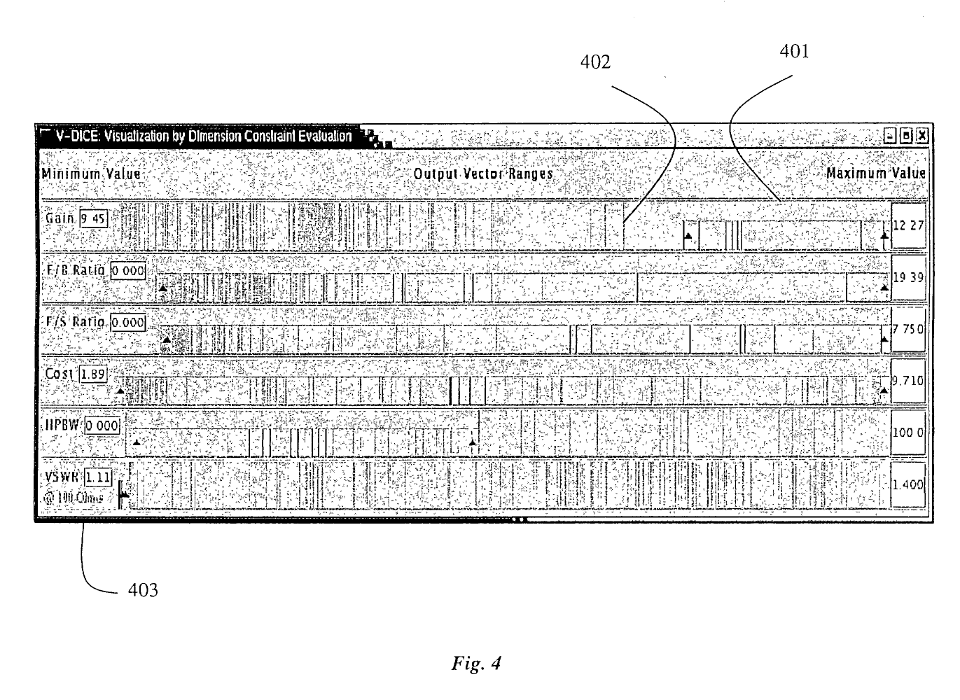

A saved antenna can be investigated further by selecting it, which brings up an additional display in which details of the antenna's design can be examined. Besides presenting a visualization that clusters similar antennas, the system also affords users the opportunity to explore the tradeoffs between the performance metrics of the antennas as shown in FIG. 4.

Each of the sliders 401 in FIG. 4 corresponds to one dimension in the performance vector of the selected design. Each antenna in the current design space is shown on each dimension as a vertical bar 402. This is a consequence of the dispersion process 200. The user can select sub-ranges within the dimensions using the sliders, thereby creating a visual query. The resulting selection is reflected immediately by highlighting in the thumbnail display. Furthermore, the selection is also shown in the dimension rows by fading the vertical value bars of unselected antennas. This allows the user to perceive relationships between different performance measures and thus better understand design tradeoffs. For example, selecting the higher-gain antennas shows the expected clustering in cost (total wire length) as well as the low VSWRs these antennas would achieve when fed with the design impedance of 100 Ω.

Iterations

The search for an antenna designs may require many iterations of the process described above. For example, a “good” design is not strictly worse than any other performance vectors, based on some user selected vector direction. During these iterations, some designs can be discarded, and the selected designs can be marked during visualization, and not considered further during subsequent iterations to increase the amount of dispersion.

Having explored performance tradeoffs, the user can make another visual query to determine a starting sample to which the dispersion process is applied in a next round of sampling. Moreover, this query also delineates the region R 132 of allowable performance vectors, see FIGS. 1 and 2. Any candidate design that falls outside the region R is rejected. Therefore, the samples for the next round are concentrated in the regions of the design space of interest to the user, thus increasing the likelihood that the design space will contain a useful antenna. Eventually, when the design space is sufficiently focused, the user may invoke a standard optimization algorithm to perfect the design of some of the antennas in the sample by looking for their nearest locally optimal designs.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for designing antennas, comprising:
supplying antenna design parameters to produce an antenna specification;
parsing the design specification to produce free variables and constraints;
generating a random sampling of a set of antenna designs from the free variables and constraints in the form of performance vectors;
dispersing the performance vectors in a design space;
visualizing the performance vectors as antenna designs in the design space; and
selecting a particular antenna design as a useful antenna design.

2. The method of claim 1 further comprising:
repeating the generating, dispersing, visualizing, and selecting to identify a set of useful antenna designs.

3. Then method of claim 1 wherein the design specification includes antenna geometry and physical-parameter inputs.

4. Then method of claim 1 wherein the design specification includes minimum and maximum values for the free variables.

5. The method of claim 1 wherein the design specification is in the form of an editable XML file.

6. The method of claim 1 wherein the each performance vector contains real numbers that represent antenna gain, front-to-back ratio, front-to-side lobe ratio, cost, half-power beam width, and voltage standing-wave ratio for a given input impedance.

7. The method of claim 1 wherein a diversity of the performance vectors is increased by maximizing a difference metric between the performance vectors.

8. The method of claim 7 wherein the difference metric is a Euclidean distance.

9. The method of claim 1 wherein the performance metric is determined by a simulator.

10. The method of claim 1 wherein the dispersion is parallelized.

11. The method of claim 1 wherein the visualizing displays thumbnail images of gain plots for each antenna design.

12. The method of claim 13 further comprising:
clustering antenna designs with similar performance vectors.

13. The method of claim 1 wherein the visualizing includes a plurality of sliders, each sliders corresponding to one dimension in the performance vector of the selected antenna design.

14. The method of claim 1 further comprising:
defining a region of allowable performance vectors.

15. The method of claim 1 further comprising:
weighting selected performance vectors.

16. The method of claim 1 further comprising:
warping selected performance vectors by a non-linear function.

17. A system for designing antennas, comprising:
a file of antenna specification;
a parser configured to parse the design specification into free variables and constraints;
means for generating a random sampling of a set of antenna designs from the free variables and constraints in the form of performance vectors;
means for dispersing the performance vectors in a design space;
an output device for visualizing the performance vectors as antenna designs in the design space; and
an input device for selecting a particular antenna design as a useful antenna design.
